(19) United States
(12) Patent Application Publication
(10) Pub. No.: US 2022/0101194 A1
(43) Pub. Date: Mar. 31, 2022

(54) METHOD, ELECTRONIC DEVICE, AND COMPUTER PROGRAM PRODUCT FOR PROCESSING MACHINE LEARNING MODEL

(71) Applicant: EMC IP Holding Company LLC, Hopkinton, MA (US)

(72) Inventors: Jinpeng Liu, Shanghai (CN); Jin Li, Shanghai (CN)

(21) Appl. No.: 17/082,867

(22) Filed: Oct. 28, 2020

(30) Foreign Application Priority Data
Sep. 30, 2020 (CN) 202011068896.9

(51) Int. Cl. G06N 20/00; G06F 16/901; G06F 9/48; G06F 8/41

(52) U.S. Cl. CPC G06N 20/00; G06F 8/433; G06F 9/4881; G06F 16/9024

(57) ABSTRACT

Embodiments of the present disclosure relate to a method, an electronic device, and a computer program product for processing a machine learning model. The method includes: acquiring a computational graph, wherein nodes represent functions related to the machine learning model, and directed edges represent dependencies between the functions; determining multiple sequential portions of the computational graph, wherein the multiple portions will be executed sequentially and functions corresponding to nodes in each portion can be executed in parallel; and assigning, to the multiple portions, execution instances for executing functions corresponding to nodes in the corresponding portions, wherein the number of execution instances assigned to each portion is associated with time required to execute functions corresponding to nodes in the portion. With the technical solution of the present disclosure, it is possible to facilitate the parallel computation of the machine learning model and improve the efficiency of processing the machine learning model.

### RELATED APPLICATION(S)

The present application claims priority to Chinese Patent Application No. 202011068896.9, filed Sep. 30, 2020, and entitled “Method, Electronic Device, and Computer Program Product for Processing Machine Learning Model,” which is incorporated by reference herein in its entirety.

### FIELD

Embodiments of the present disclosure generally relate to the field of artificial intelligence, and in particular, to a method, an electronic device, and a computer program product for processing a machine learning model.

### BACKGROUND

In recent years, with the advancement of artificial intelligence technology, machine learning or deep learning (DL) has promoted the development of many fields. At the same time, machine learning models have become more and more complex and require larger and larger data sets. Therefore, the execution of such a machine learning model requires more computing resources. At present, due to the limitation of the computing power of processing units such as central processing units and communication bandwidths with peripheral computing devices, it is often difficult for the computing resources of a single machine to meet the requirements of large-scale machine learning models, and thus machine learning models cannot be effectively deployed.

### SUMMARY

Embodiments of the present disclosure provide a method, an electronic device, and a computer program product for processing a machine learning model.

In a first aspect of the present disclosure, a method for processing a machine learning model is provided. The method includes: acquiring a computational graph, wherein nodes in the computational graph represent functions related to the machine learning model, and directed edges in the computational graph represent dependencies between the functions; determining multiple sequential portions of the computational graph, wherein the multiple portions will be executed sequentially and functions corresponding to nodes in each portion can be executed in parallel; and assigning, to the multiple portions, execution instances for executing functions corresponding to nodes in the corresponding portions, wherein the number of execution instances assigned to each portion is associated with time required to execute functions corresponding to nodes in the portion.

In a second aspect of the present disclosure, an electronic device is provided. The device includes: at least one processing unit; and at least one memory which is coupled to the at least one processing unit and stores instructions for execution by the at least one processing unit, wherein the instructions, when being executed by the at least one processing unit, cause the device to perform actions including: acquiring a computational graph, wherein nodes in the computational graph represent functions related to the machine learning model, and directed edges in the computational graph represent dependencies between the functions; determining multiple sequential portions of the computational graph, wherein the multiple portions will be executed sequentially and functions corresponding to nodes in each portion can be executed in parallel; and assigning, to the multiple portions, execution instances for executing functions corresponding to nodes in the corresponding portions, wherein the number of execution instances assigned to each portion is associated with time required to execute functions corresponding to nodes in the portion.

In a third aspect of the present disclosure, a computer program product is provided. The computer program product is tangibly stored on a non-transitory computer-readable medium and includes machine-executable instructions, wherein the machine-executable instructions, when being executed, cause a machine to perform any step of the method described according to the first aspect of the present disclosure.

This Summary is provided in order to introduce the selection of concepts in a simplified form, which will be further described in the Detailed Description below. The Summary is not intended to identify key features or essential features of the embodiments of the present disclosure, nor is it intended to limit the scope of the embodiments of the present disclosure.

### BRIEF DESCRIPTION OF THE DRAWINGS

The above and other objectives, features, and advantages of the present disclosure will become more apparent from the following detailed description of example embodiments in combination with the accompanying drawings. In the example embodiments of the present disclosure, the same reference numerals generally represent the same parts.

FIG. 1 illustrates a schematic diagram of example environment 100 in which a device and/or a method according to the embodiments of the present disclosure may be implemented;

FIG. 2 illustrates a flowchart of method 200 for processing a machine learning model according to an embodiment of the present disclosure;

FIG. 3 illustrates a flowchart of method 300 for dividing a computational graph into multiple portions according to an embodiment of the present disclosure;

FIGS. 4A to 4D respectively illustrate schematic diagrams of execution instance assigning processes 401 to 404 according to embodiments of the present disclosure; and

FIG. 5 illustrates a schematic block diagram of example device 500 that can be used to implement the embodiments of the present disclosure.

The same or corresponding reference numerals in the various drawings represent the same or corresponding portions.

### DETAILED DESCRIPTION

Hereinafter, illustrative embodiments of the present disclosure will be described in more detail with reference to the accompanying drawings. Although the illustrative embodiments of the present disclosure are shown in the drawings, it should be understood that the present disclosure can be implemented in various forms and should not be limited by the embodiments set forth herein. Rather, these embodiments are provided so that this disclosure will be more thorough and complete, and will fully convey the scope of the present disclosure to those skilled in the art.

As used herein, the term “include” and variations thereof mean open-ended inclusion, for example, “including but not limited to.” Unless specifically stated, the term “or” means “and/or.” The term “based on” means “based at least in part on.” The terms “an example embodiment” and “an embodiment” mean “at least one embodiment.” The term “another embodiment” means “at least one further embodiment.” The terms “first,” “second,” etc., may refer to different or the same objects. Other explicit and implicit definitions may also be included below.

When using machine learning models to process data, inference applications can provide services simultaneously for many user devices, such as mobile phones or autonomous vehicles. From the perspective of the inference applications, all these data frames are independent samples of applications with independent inference results on other data frames from the same or different user devices.

In conventional machine learning model processing, N-instance solutions or parallel solutions such as pipelines can be adopted. However, when an N-instance solution is adopted, the entire model needs to be loaded into each execution instance. Therefore, for this type of solution, even when there are sufficient computing resources, for example, when there are sufficient central processing unit cores or dedicated processing unit cores such as graphics processing units (GPUs), there may possibly be insufficient memory for new inference application instances. Although some conventional solutions involve the division of machine learning models, the adopted division algorithm is based on the computational cost of the number of floating-point operations per second (FLOPS), but due to estimation errors or due to computational input/output limitations defined by a computational graph, it may be impossible to balance the loads of different portions as divided, resulting in stagnation of the pipeline. At the same time, for different processing units, such as central processing units, dedicated processing units, or field programmable gate arrays, the time for calculating the number of floating-point operations per second is also different. Therefore, such conventional solutions can only be used in computing units of the same type. Furthermore, the number of divided portions in such conventional solutions is statically determined by the number of computing units, so sometimes due to the computational input/output limitations defined by the computational graph, it will be very difficult to achieve the division into portions. In addition, the pipeline in the above conventional solutions uses only a single execution instance for each divided portion, so even if there are sufficient computing resources in the computing device, these computing resources cannot be fully used by the pipeline.

In order to at least partially solve the above problems and one or more of other potential problems, the embodiments of the present disclosure provide a solution for processing a machine learning model. With this solution, the number of divided portions in a pipeline for processing a machine learning model is based on the division of a computational graph, so that, for different computational graphs, the number of divided portions in the pipeline is dynamic. Therefore, the solution for processing a machine learning model of the present disclosure can adaptively process different machine learning models, and for different machine learning models, the solution can assign, to different divided portions, the number of execution instances required to execute functions corresponding to nodes in every portion.

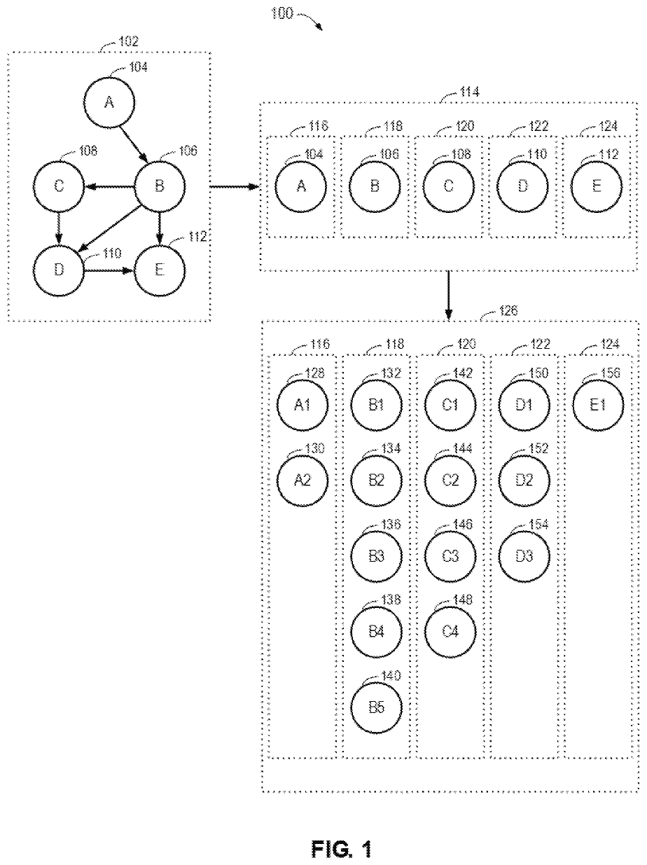

FIG. 1 illustrates a schematic diagram of example environment 100 in which a device and/or a method according to the embodiments of the present disclosure may be implemented. According to an embodiment of the present disclosure, computational graph 102 shown in FIG. 1 is initial input data in example environment 100. Computational graph 102 includes node A 104, node B 106, node C 108, node D 110, and node E 112. The nodes in computational graph 102 represent functions related to the machine learning model. Computational graph 102 also includes dependencies between the functions. For example, a directed edge in computational graph 102 indicates that the input of a function corresponding to the end point of the directed edge depends on the output of a function corresponding to the start point of the directed edge.

Each node in computational graph 102 represents a function in the machine learning model, and the connecting line between the nodes represents the dependency between the functions. For example, the output of node B 106 is passed to node D 110, and the output of node C 108 is also passed to node D 110, so node D 110 depends on node B 106 and node C 108. Computational graph 102 in FIG. 1 is only used as an example to describe the computational graph. The number of nodes in the computational graph and the structure of the computational graph can vary in other embodiments. In addition, according to an embodiment of the present disclosure, computational graph 102 may be a directed acyclic graph.

In addition, in computational graph 102, node A 104 has no directed edges pointing to it, so the in-degree of node A 104 is 0. Node B 106 and node C 108 each have one directed edge pointing to them, so the in-degrees of node B 106 and of node C 108 are 1. Node D 110 and node E 112 each have two directed edges pointing to them, so the in-degrees of node D 110 and of node E 112 are 2.

According to an embodiment of the present disclosure, example environment 100 may include a manager (not shown) which may receive an intermediate representation of the machine learning model and generate computational graph 102.

The intermediate representation of the machine learning model can be obtained by compiling, by a compiler, the machine learning model written in a source language. Compiling is a process of converting source code/original code written in a programming language into machine code or native code of a target architecture. The intermediate representation is a data structure or code used internally by the compiler or virtual machine to represent the source code, and has nothing to do with the source language or a target language. In some embodiments, the intermediate representation of the machine learning model can be obtained in other ways. For example, a programmer writes, according to compiling rules of the compiler, the machine learning model written in the source language into the intermediate representation of the machine learning model. It should be understood that any suitable way can be used to obtain the intermediate representation of the machine learning model written in the source language.

The intermediate representation of the machine learning model can be described by structured text. For example, the intermediate representation may include an intermediate representation of the machine learning model, which is described in the Javascript Object Notation (JSON) or Extensible Markup Language (XML) format. It should be understood that a person skilled in the art can describe the intermediate representation of the machine learning model in any suitable language as needed.

The intermediate representation of the machine learning model is transmitted to the manager. The manager is used to process the received intermediate representation of the machine learning model to realize the division of the machine learning model. The manager can be implemented in software or hardware.

In the solution for processing a machine learning model of the present disclosure, central processing units and dedicated processing units can be used simultaneously, and the use of only the central processing units or only the dedicated processing units can also be supported. In addition, in the solution for processing a machine learning model of the present disclosure, each divided portion may be jointly executed by multiple instances, or may be jointly executed by instances of multiple processing units. Finally, in the solution for processing a machine learning model of the present disclosure, execution instances assigned to each divided portion are dynamically divided at runtime, and the assignment is based on the time required for each computation.

As shown in FIG. 1, computational graph 102 is divided by the manager into a set of sequential portions 114, wherein the set of portions 114 include first portion 116, second portion 118, third portion 120, fourth portion 122, and fifth portion 124. In the set of portions 114 shown in FIG. 1, first portion 116 includes node A 104, second portion 118 includes node B 106, third portion 120 includes node C 108, fourth portion 122 includes node D 110, and fifth portion 124 includes node E 112. In some embodiments, the manager will divide computational graph 102 based on the in-degrees of the nodes in computational graph 102, and the in-degree of a node represents the number of directed edges pointing to this node.

The manager then assigns execution instances to the obtained first portion 116, second portion 118, third portion 120, fourth portion 122, and fifth portion 124. In the set of portions 126 to which execution instances are assigned as shown in FIG. 1, first portion 116 is assigned with execution instance A1 128 and execution instance A2 130; second portion 118 is assigned with execution instance B1 132, execution instance B2 134, execution instance B3 136, execution instance B4 138, and execution instance B5 140; third portion 120 is assigned with execution instance C 1 142, execution instance C2 144, execution instance C3 146, and execution instance C4 148; fourth portion 122 is assigned with execution instance D1 150, execution instance D2 152, and execution instance D3 154; and fifth portion 124 is assigned with execution instance E1 156.

According to an embodiment of the present disclosure, the number of execution instances assigned to each portion is based on the time required to execute functions corresponding to nodes in the corresponding portion. In this embodiment, execution instance A1 128 and execution instance A2 130 are provided by central processing unit 1, execution instance B1 132, execution instance B2 134, execution instance B3 136, execution instance B4 138, and execution instance B5 140 are provided by dedicated processing unit 1 and dedicated processing unit 2, execution instance C 1 142, execution instance C2 144, execution instance C3 146, and execution instance C4 148 are provided by dedicated processing unit 3, and execution instance E1 156 is provided by central processing unit 2.

Therefore, in example environment 100, for different machine learning models, it is possible to assign, to different divided portions, the number of execution instances required to execute functions corresponding to nodes in every portion.

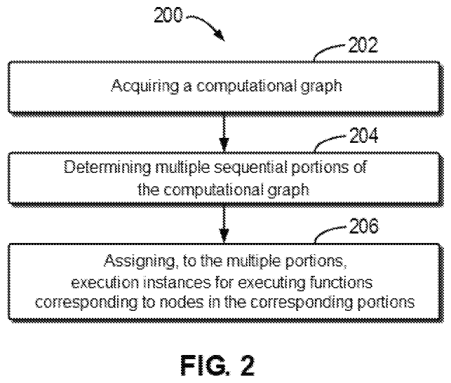

FIG. 2 illustrates a flowchart of method 200 for processing a machine learning model according to an embodiment of the present disclosure. Method 200 may be implemented by the manager described (but not shown) with reference to example environment 100, or may also be implemented by other suitable devices. It should be understood that method 200 for processing a machine learning model may further include additional steps not shown and/or may omit the shown steps, and the scope of the embodiments of the present disclosure is not limited in this respect.

At block 202, the manager acquires a computational graph. According to an embodiment of the present disclosure, the nodes in the computational graph represent functions related to the machine learning model, and the directed edges in the computational graph represent dependencies between the functions.

In some embodiments, the nodes in the computational graph represent the functions in the machine learning model. A directed edge in the computational graph indicates that the input of a function corresponding to the end point of the directed edge depends on the output of a function corresponding to the start point of the directed edge. Alternatively or additionally, the computational graph is a directed acyclic graph.

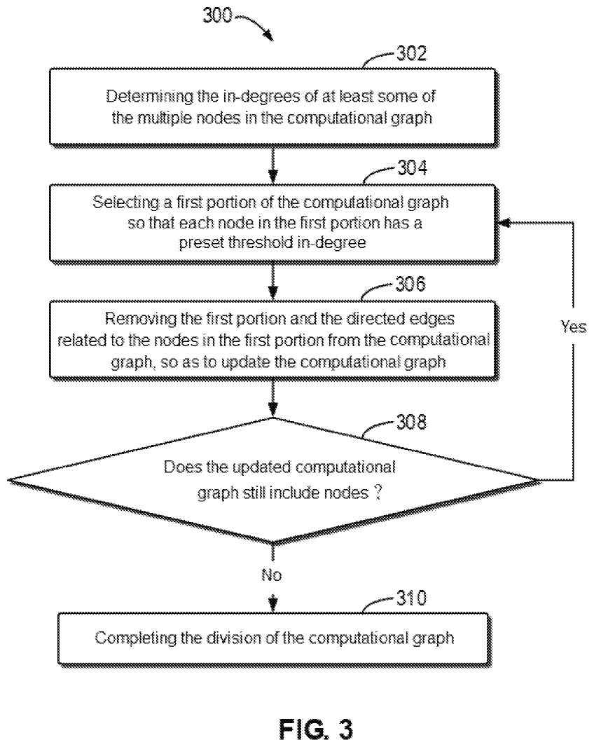

At block 204, the manager determines multiple sequential portions of the computational graph. According to an embodiment of the present disclosure, the determined multiple portions will be executed in the aforementioned sequence and functions corresponding to nodes in each portion can be executed in parallel. The manager divides the computational graph and divides it into multiple groups of functions that need to be executed sequentially. The functions in each group of functions do not depend on each other, so they can be executed in parallel. The process of dividing the computational graph into multiple portions will be described in detail below in connection with FIG. 3.

As shown in FIG. 1, computational graph 102 can be divided into a set of portions 114, wherein the set of portions 114 include first portion 116, second portion 118, third portion 120, fourth portion 122, and fifth portion 124. The above multiple portions need to be executed sequentially, because the input of functions in the following portion needs to depend on the output of functions in the previous portion, and the functions in various portions can be executed in parallel.

Since the processing of the machine learning model is performed at the function level, not at the instruction level, the above division of computational graph 120 makes the processing of the machine learning model more effective, and more versatile and feasible, eliminates the need to perform communication between and within layers of the deep learning model, and also eliminates the need to divide parameter tensors and error tensors. In addition, the above division method is more effective in time and space, and can perform the division before running the machine learning model, thereby saving the training time of the machine learning model.

According to some embodiments of the present disclosure, the manager may further divide the multiple divided portions. The manager may determine execution instances to be assigned to a portion. If these execution instances come from multiple processing units, the manager may divide this portion into multiple sub-portions, and assign execution instances to each sub-portion, wherein the execution instances assigned to each sub-portion come from different processing units, and the number of the execution instances assigned to each sub-portion is associated with the time required to execute functions corresponding to nodes in this sub-portion. For example, regarding the set of portions 114 into which computational graph 102 is divided, the manager may determine that execution instance B1 132, execution instance B2 134, execution instance B3 136, execution instance B4 138, and execution instance B5 140 to be assigned to second portion 118 are provided by dedicated processing unit 1 and dedicated processing unit 2, respectively. At this moment, the manager may divide second portion 118 into a first sub-portion and a second sub-portion, assign, to the first sub-portion, execution instance B1 132 and execution instance B2 134 that are provided by dedicated processing unit 1, and assign, to the second sub-portion, execution instance B3 136, execution instance B4 138, and execution instance B5 140 that are provided by dedicated processing unit 2.

By further dividing a portion into multiple sub-portions, the functions performed by each processing unit can be further subdivided.

At block 206, the manager assigns, to the multiple portions determined in block 204, execution instances for executing functions corresponding to nodes in the corresponding portion. According to an embodiment of the present disclosure, the number of execution instances assigned to each portion is associated with the time required to execute functions corresponding to nodes in this portion.

According to an embodiment of the present disclosure, the execution instances assigned to the multiple portions determined in block 204 may come from an execution instance pool provided by different processing units, and the processing units that provide execution instances in the execution instance pool may include, for example, central processing units and dedicated processing units, and these execution instances may be, for example, threads, processes, etc. Since functions corresponding to nodes in each divided portion have different requirements for processing capacity and computation amount, the providers of execution instances suitable for each portion may also be different. Therefore, the manager may determine, based on functions corresponding to nodes in a portion, the type of processing units for providing execution instances that are assigned to this portion, and may then assign, to this portion from the execution instance pool, execution instances provided by processing units of the determined type, for example, execution instances provided by a central processing unit or a dedicated processing unit.

According to an embodiment of the present disclosure, the manager may assign, to the divided portions, execution instances for executing functions corresponding to nodes in these portions when executing functions corresponding to nodes in the corresponding portions. The manager may assign a preset number of execution instances to one of the multiple portions of computational graph 102 determined in block 204, and, during execution of functions corresponding to nodes in the one portion, adjust the execution instances assigned to the one portion.

According to some embodiments of the present disclosure, the manager may assign, to each of the multiple portions of computational graph 102 determined in block 204, a large, preset number of execution instances sufficient to execute functions corresponding to nodes in each portion, for example, based on statistical data, the analysis of computational graph 102, or machine learning. Since the solution for processing a machine learning model according to the embodiments of the present disclosure adopts a pipeline processing manner, when a data frame enters a certain portion, execution instances will be assigned to the data frame to perform computation for this data frame. Meanwhile, when an execution instance completes the computation for a certain data frame, this execution instance can be used for the computation of a subsequent data frame entering this portion. Therefore, according to an embodiment of the present disclosure, in the computation of each portion, when a new data frame enters this portion, it is first determined whether any previous execution instance used to perform computation on other data frames has completed the computation and is in the released state; and if there are such execution instances, these execution instances will be used first for the computation of new data frames; or if there are no such execution instances, execution instances that have never been used will be used for the computation of new data frames. In this way, the situation where all execution instances are sparsely used can be avoided, and certain assigned execution instances can be guaranteed to be used continuously, thereby improving the use efficiency of these execution instances.

Afterwards, the manager can recycle, during the execution of functions corresponding to nodes in each portion, execution instances among the large, preset number of execution instances that are not used during the execution of functions corresponding to nodes in the corresponding portion. The remaining execution instances in each portion after reclamation are then the execution instances required to execute functions corresponding to nodes in the corresponding portion.

It should be understood that the number of the large, preset number of execution instances assigned by the manager to each of the multiple portions of computational graph 102 determined in block 204 may not be the same, but instead, a different number of execution instances can be assigned to each portion by the manager based on statistical data, an analysis of computational graph 102, or machine learning.

By adopting the methods in these embodiments, an uninterrupted operation of the pipeline for processing the machine learning model can be ensured, thereby helping to efficiently process the machine learning model.

According to some other embodiments of the present disclosure, the manager may assign a small, preset number of execution instances to each of the multiple portions of computational graph 102 determined in block 204. Afterwards, during the execution of functions corresponding to nodes in each portion, if the manager determines that this preset number is less than the number of execution instances required to execute functions corresponding to nodes in one portion, it determines the number of execution instances that need to be added to the one portion, and then assigns the determined number of execution instances to the one portion.

It should be understood that the manager determining the number of execution instances that need to be added to the one portion and the assignment of the determined number of execution instances to the one portion may be repeatedly executed. For example, the manager may first determine that 1 execution instance needs to be added to the one portion and then assign 1 execution instance to the one portion. Afterwards, as the computation further proceeds, the manager may continue to determine that it is still necessary to add 1 execution instance to the one portion, and then further assign 1 execution instance to the one portion.

In addition, if the manager determines that the preset number is less than the number of execution instances required to execute functions corresponding to nodes in one portion, it may not determine the number of execution instances that need to be added to the one portion, but instead, increase the number of execution instances provided to the one portion in the manner of directly assigning another preset number of execution instances to the one portion. This other preset number may be the same as or different from the preset number.

In addition, the number of the small, preset number of execution instances assigned by the manager to each of the multiple portions of computational graph 102 determined in block 204 may not be the same, but instead, a different number of execution instances can be assigned to each portion by the manager based on statistical data, an analysis of computational graph 102, or machine learning.

By adopting the methods in these embodiments, it is unnecessary to assign too many execution instances initially, so that only a moderately sized execution instance pool needs to be maintained, thus helping to save computing resources of the processing units.

The flowchart of method 200 for processing a machine learning model according to an embodiment of the present disclosure is described above with reference to FIG. 2. The process for dividing the computational graph in block 204 of FIG. 2 will be described in detail below with reference to FIG. 3, where FIG. 3 illustrates a flowchart of method 300 for dividing a computational graph into multiple portions according to an embodiment of the present disclosure.

At block 302, the manager determines the in-degrees of at least some of the multiple nodes in the computational graph, wherein the in-degree of one node represents the number of directed edges pointing to the node. In the computational graph, each node has some directed edges, for example, a directed edge of which the start point is the node or a directed edge of which the end point is the node. In order to divide the nodes, the in-degrees of the nodes are used to divide the computational graph, that is, a node is divided by determining the number of directed edges of which the end point is the node. In some embodiments, the computational graph is a directed acyclic graph.

As shown in FIG. 1, in computational graph 102, node A 104 has no directed edges pointing to it, so the in-degree of node A 104 is 0. Node B 106 and node C 108 each have one directed edge pointing to them, so the in-degrees of node B 106 and of node C 108 are 1. Node D 110 and node E 112 each have two directed edges pointing to them, so the in-degrees of node D 110 and of node E 112 are 2.

At block 304, the manager selects a first portion of the computational graph so that each node in the first portion has a preset threshold in-degree. In some embodiments, the threshold in-degree is zero. After determining the in-degree of each node in the computational graph, the manager may select a node with the threshold in-degree from all nodes as the selected first portion of the computational graph.

As shown in FIG. 1, a node with the threshold in-degree of 0 is selected from computational graph 102 as the first portion. Therefore, node A 104 is selected as the first portion.

At block 306, the manager removes the first portion and the directed edges related to the nodes in the first portion from the computational graph, so as to update the computational graph. After the manager selects the first portion of the nodes, in order to select other sequential portions, the nodes in the first portion of the computational graph and the directed edges related to the nodes are removed to form the updated computational graph, and the in-degrees of the nodes are updated.

As shown in FIG. 1, when the manager divides computational graph 102, the node with the in-degree of 0 is selected as the first portion. Then the node with an in-degree of 0 is removed, that is, node A 104 is removed. The manager also deletes the directed edges related to the node in the first portion to form the updated computational graph. In addition, the manager adjusts the in-degrees of the nodes in the updated computational graph.

At block 308, the manager determines whether the updated computational graph still includes nodes. If the updated computational graph includes no node, then at block 310, the manager determines that the division of the computational graph is completed.

If the updated computational graph still includes nodes, the operation returns to block 304 to use the updated computational graph as the computational graph to be processed. Then the manager selects, based on the in-degrees of the nodes, a node with the in-degree of 0 from the updated computational graph as the second portion, such as node B 106 in FIG. 2. Then, iterative processing is performed according to the above method until all nodes are divided.

Finally, computational graph 102 can be divided into multiple portions, wherein first portion 116 includes node A 104, second portion 118 includes node B 106, third portion 120 includes node C 108, fourth portion 122 includes node D 110, and fifth portion 124 includes node E 112. Since the input of the functions in the following portion depends on the output of the functions in the previous portion, each portion must be executed sequentially. However, there is no dependency between the nodes in various portions, so they can be executed in parallel.

With the above method, the processing of the machine learning model divides the machine learning model at the function level to make the processing of the machine learning model more effective and more versatile and feasible. In addition, this division has a low time complexity, and it does not require too much auxiliary data, and thus is more spatially efficient.

According to an embodiment of the present disclosure, the manager may also analyze parameters required for the computation of functions corresponding to nodes in the multiple divided portions. This is to help all execution instances in the processing unit share only one copy of pre-training parameters, so as to reduce the requirement for memory. In some embodiments, if it is not possible to accommodate all execution instances for the computation of a certain function into a single processing unit due to the limitation of computing resources, the manager may deploy some required execution instances to other processing units. In this case, each processing unit for the computation of this function will have a copy of the parameters required for the computation of this function.

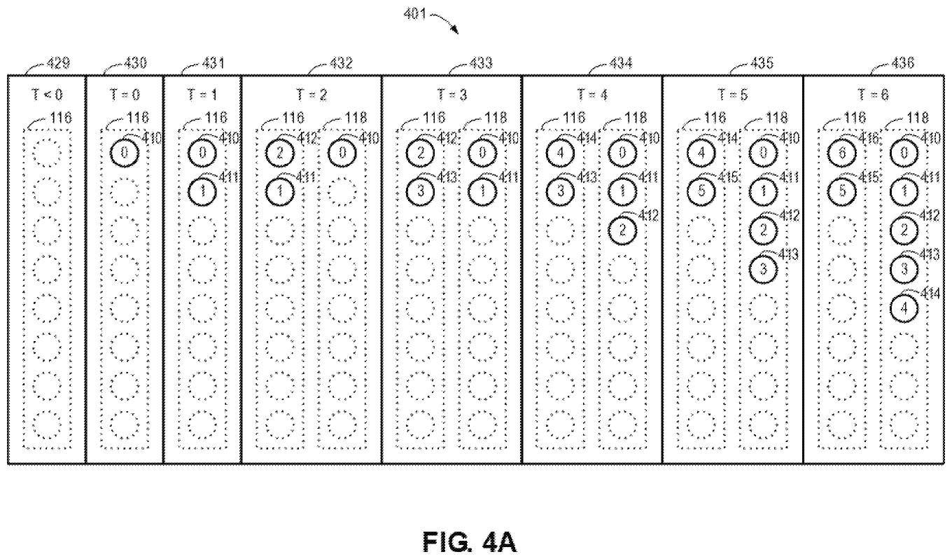

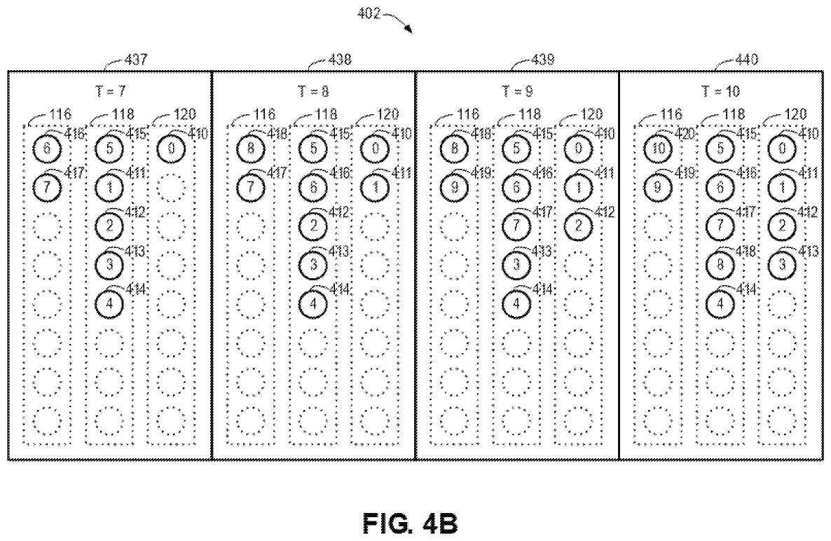

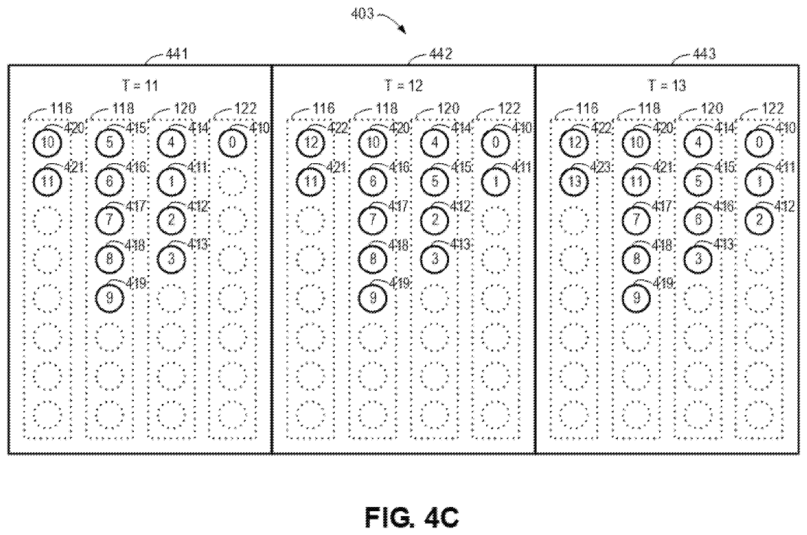

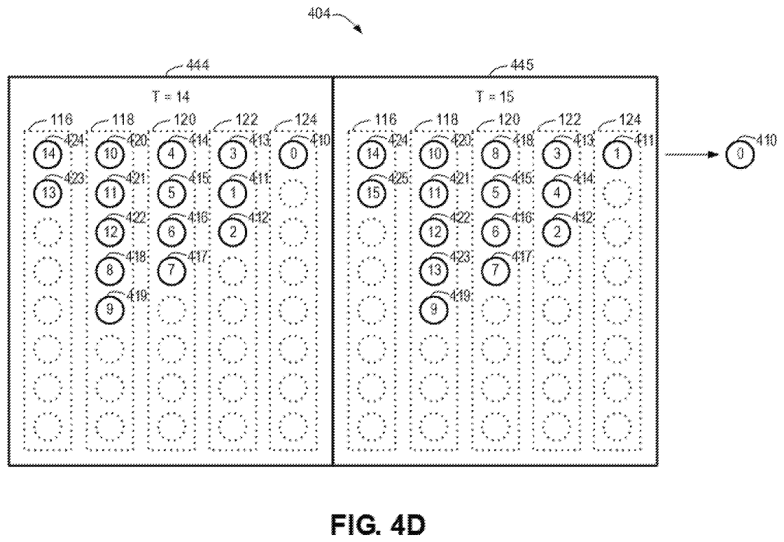

FIGS. 4A to 4D respectively illustrate schematic diagrams of execution instance assigning processes 401, 402, 403, and 404 according to embodiments of the present disclosure. In FIGS. 4A to 4D, reference numerals 429 to 445 respectively represent situations where the set of portions into which computational graph 102 is divided participate in processing data frames at time T<0, T=0 . . . T=15. According to an embodiment of the present disclosure, the unit of T is 1 second, but this unit is only for illustrative purposes and does not constitute a limitation to the present disclosure. In FIGS. 4A to 4D, reference numerals 116, 118, 120, 122, and 124 respectively represent the first portion, the second portion, the third portion, the fourth portion, and the fifth portion into which computational graph 102 is divided. Dotted or solid circles in each portion represent execution instances assigned to this portion, wherein a dotted circle represents an execution instance that is not used, a solid circle represents an execution instance that is being used to execute a function, and reference numerals 410 to 425 on solid circles respectively represent data frames 0 to 15 that enter the computation for the machine learning model at time T0 to T15 and are thus subject to computation processing.

At time T<0 indicated by reference numeral 429, first portion 116 is assigned 8 execution instances, but no data frame enters the computation for the machine learning model at this moment.

At time T=0 indicated by reference numeral 430, data frame 0 410 enters first portion 116 and is executed by the first execution instance that has not been used.

At time T=1 indicated by reference numeral 431, data frame 1 411 enters first portion 116. Since the execution time of the function corresponding to the node of first portion 116 is 2 seconds, data frame 0 410 has not yet completed execution at this moment, so data frame 1 411 is executed by the second execution instance that has not been used in first portion 116.

At time T=2 indicated by reference numeral 432, data frame 2 412 enters first portion 116. Since the execution time of the function corresponding to the node of first portion 116 is 2 seconds, data frame 0 410 has completed execution and entered second portion 118. Second portion 118 is also assigned 8 execution instances, and the first execution instance of second portion 118 starts to execute data frame 0 410. At the same time, since the first execution instance in first portion 116 has completed the execution of data frame 0 410, it starts to execute data frame 2 412 which enters first portion 116. At this moment, since every time a new data frame enters first portion 116, first portion 116 will have a previous execution instance that has completed the execution of a function and can be used to execute this new data frame, so first portion 116 no longer needs to use other unused execution instances, thus reaching a balance state.

From time T=3 to time T=6 indicated by reference numerals 433 to 436, data frame 3 413 to data frame 6 416 successively enter the computation for the machine learning model, and data frame 3 413 and data frame 4 414 have completed execution in first portion 116 and entered second portion 118. Since the execution time of the function corresponding to the node of second portion 118 is 5 seconds, data frame 0 410 to data frame 4 414 are still in an executed state in second portion 118.

At time T=7 indicated by reference numeral 437, data frame 7 417 enters first portion 116. Since the execution time of the function corresponding to the node in second portion 118 is 5 seconds, data frame 0 410 has completed execution at this moment and entered third portion 120. The first execution instance in second portion 118 which executed data frame 0 410 at time T=6 is now used to execute data frame 5 415 which has completed execution in first portion 116 at time T=7 and entered second portion 118. At this moment, since every time a new data frame enters second portion 118, second portion 118 will have a previous execution instance that has completed the execution of the function and can be used to execute this new data frame, so second portion 118 no longer needs to use other unused execution instances, thus reaching a balanced state.

At time T=8 to time T=10 indicated by reference numerals 438 to 440, data frame 8 418 to data frame 10 420 successively enter the computation for the machine learning model, and data frame 6 416 to data frame 8 418 have completed execution in first portion 116 and entered second portion 118, and data frame 1 411 to data frame 3 413 have completed execution in second portion 118 and entered third portion 120. Since the execution time of the function corresponding to the node of third portion 120 is 4 seconds, data frame 0 410 to data frame 3 413 are still in an executed state in third portion 120.

At time T=11 indicated by reference numeral 441, data frame 11 421 enters first portion 116. Since the execution time of the function corresponding to the node in third portion 120 is 4 seconds, data frame 0 410 has completed execution at this moment and entered fourth portion 122. The first execution instance in third portion 120 that executed data frame 0 410 at time T=10 is now used to execute data frame 4 414 which has completed execution in second portion 118 at time T=11 and entered third portion 120. At this moment, since every time a new data frame enters third portion 120, third portion 120 will have a previous execution instance that has completed the execution of a function and can be used to execute this new data frame, third portion 120 no longer needs to use other unused execution instances, thus reaching a balanced state.

At time T=12 and time T=13 indicated by reference numerals 442 and 443, data frame 12 422 to data frame 13 423 successively enter the computation for the machine learning model, data frame 10 420 and data frame 11 421 have completed execution in first portion 116 and entered second portion 118, data frame 5 415 and data frame 6 416 have completed execution in second portion 118 and entered third portion 120, and data frame 1 411 and data frame 2 412 have completed execution in third portion 120 and entered fourth portion 122. Since the execution time of the function corresponding to the node of fourth portion 122 is 3 seconds, data frame 0 410 to data frame 2 412 are still in an executed state in fourth portion 122.

At time T=14 indicated by reference numeral 444, data frame 14 424 enters first portion 116. Since the execution time of the function corresponding to the node in fourth portion 122 is 3 seconds, data frame 0 410 has completed execution at this moment and entered fifth portion 124. The first execution instance in fourth portion 122 that executed data frame 0 410 at time T=13 is now used to execute data frame 3 413 which has completed execution in third portion 120 at time T=14 and entered fourth portion 122. At this moment, since every time a new data frame enters fourth portion 122, fourth portion 122 will have a previous execution instance that has completed the execution of a function and can be used to execute this new data frame, fourth portion 122 no longer needs to use other unused execution instances, thus reaching a balanced state.

At time T=15 indicated by reference numeral 445, data frame 15 425 enters first portion 116 of the computation for the machine learning model. Since the execution time of the function corresponding to the node of fifth portion 124 is 1 second, data frame 0 410 has completed execution at this moment and is used as the machine computation output of the computation for the machine learning model. The first execution instance in fifth portion 124 that executed data frame 0 410 at time T=14 is now used to execute data frame 1 411 which has completed execution in fourth portion 122 at time T=15 and entered fifth portion 124. At this moment, since every time a new data frame enters fifth portion 124, fifth portion 124 will have a previous execution instance that has completed the execution of a function and can be used to execute this new data frame, fifth portion 124 no longer needs to use other unused execution instances, thus reaching a balanced state. At this moment, first portion 116, second portion 118, third portion 120, fourth portion 122, and fifth portion 124 all reach a balanced state.

According to an embodiment of the present disclosure, the time required to execute a function on a data frame is not necessarily an integer time, but may also be a non-integer time, for example, 0.03 seconds. For function execution of a non-integer time, if N data frames enter the computation for the machine learning model, in extreme cases, there will be N instances for the Kth portion of the final load. If T_{K} seconds are required to execute the function corresponding to the node in the Kth portion, for each i≠K, there will be T_{K}/i instances in stage i.

In execution instance assigning processes 401 to 404 according to the embodiments of the present disclosure described with reference to FIGS. 4A to 4D, when first portion 116, second portion 118, third portion 120, fourth portion 122, and fifth portion 124 all reach the balanced state, first portion 116, second portion 118, third portion 120, fourth portion 122, and fifth portion 124 use 2, 5, 4, 3, and 1 execution instances, respectively. Since the number of execution instances initially assigned to each of these portions is 8, there are 6, 3, 4, 5, and 7 execution instances in each of these portions that are not used. At this moment, the manager can respectively recycle 6, 3, 4, 5, and 7 execution instances from the execution instances that were assigned to first portion 116, second portion 118, third portion 120, fourth portion 122, and fifth portion 124.

Related content of example environment 100 in which the device and/or method according to the embodiments of the present disclosure may be implemented, method 200 for processing a machine learning model according to the embodiments of the present disclosure, method 300 for dividing a computational graph into multiple portions according to the embodiments of the present disclosure, and execution instance assigning processes 401 to 404 according to the embodiments of the present disclosure have been described above with reference to FIG. 1 to FIG. 4D. It should be understood that the above description is provided to illustrate example embodiments of the present disclosure, and is not intended to limit the present disclosure in any way.

It should be understood that the numbers of various elements and other features and characteristics used in the embodiments of the present disclosure and the drawings are only examples, and are not intended to limit the protection scope of the embodiments of the present disclosure. The above numbers and other features and characteristics can be varied according to needs without affecting the normal implementation of the embodiments of the present disclosure.

Through the above description with reference to FIG. 1 to FIG. 4D, the technical solutions according to the embodiments of the present disclosure have many advantages over the conventional solutions. For example, with the technical solutions of the present disclosure, it is possible to facilitate the parallel computation of the machine learning model and improve the efficiency of processing the machine learning model by dynamically adjusting the number of execution instances in each portion, making full use of the computing resources of each processing unit, and saving as few model parameters as possible.

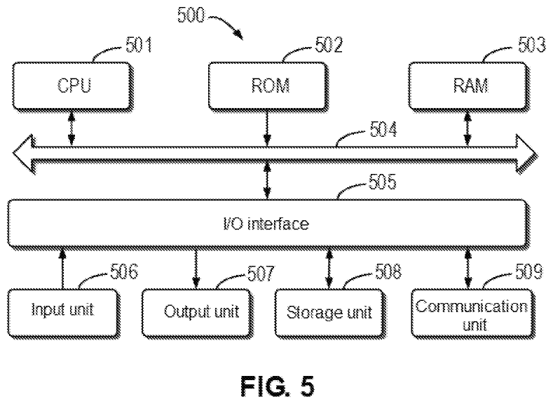

FIG. 5 illustrates a schematic block diagram of example device 500 that can be used to implement the embodiments of the present disclosure. According to an embodiment of the present disclosure, the manager described above with reference to example environment 100 in FIG. 1 but not shown in that figure may be implemented by device 500. As shown in FIG. 5, device 500 includes a processing unit, illustratively in the form of a central processing unit (CPU) 501, that may perform various appropriate actions and processing according to computer program instructions stored in read-only memory (ROM) 502 or computer program instructions loaded from storage unit 508 into random access memory (RAM) 503. In RAM 503, various programs and data required for the operation of storage device 500 may also be stored. CPU 501, ROM 502, and RAM 503 are connected to each other through bus 504. Input/output (I/O) interface 505 is also connected to bus 504.

Multiple components in device 500 are connected to I/O interface 505, including: input unit 506, such as a keyboard and a mouse; output unit 507, such as various types of displays and speakers; storage unit 508, such as a magnetic disk and an optical disk; and communication unit 509, such as a network card, a modem, and a wireless communication transceiver. Communication unit 509 allows device 500 to exchange information/data with other devices through a computer network such as the Internet and/or various telecommunication networks.

The various processes and processing described above, such as methods 200 and 300, may be performed by CPU 501. For example, in some embodiments, methods 200 and 300 may be implemented as a computer software program that is tangibly included in a machine-readable medium such as storage unit 508. In some embodiments, part or all of the computer program may be loaded and/or mounted to device 500 via ROM 502 and/or communication unit 509. One or more actions of methods 200 and 300 described above may be performed when the computer program is loaded into RAM 503 and executed by CPU 501.

The embodiments of the present disclosure may relate to a method, a device, a system, and/or a computer program product. The computer program product may include a computer-readable storage medium on which computer-readable program instructions for performing various aspects of the embodiments of the present disclosure are carried.

The computer-readable storage medium may be a tangible device that can hold and store instructions used by an instruction execution device. The computer-readable storage medium may be, for example, but is not limited to, an electric storage device, a magnetic storage device, an optical storage device, an electromagnetic storage device, a semiconductor storage device, or any suitable combination of the foregoing. More specific examples, as a non-exhaustive list, of computer-readable storage media include: a portable computer disk, a hard disk, RAM, ROM, an erasable programmable read-only memory (EPROM or a flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. Computer-readable storage media used herein are not interpreted as transient signals per se, such as radio waves or other freely propagating electromagnetic waves, electromagnetic waves propagating through waveguides or other transmission media, for example, light pulses through fiber optic cables, or electrical signal transmitted via electrical wires.

The computer-readable program instructions described herein can be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. The network adapter card or network interface in each computing/processing device receives computer-readable program instructions from the network and forwards the computer-readable program instructions for storage in a computer-readable storage medium in each computing/processing device.

Computer program instructions for performing the operations of the embodiments of the present disclosure may be assembly instructions, instruction set architecture (ISA) instructions, machine instructions, machine-related instructions, microcode, firmware instructions, state setting data, or source or object code written in any combination of one or more programming languages, wherein the programming languages include object-oriented programming languages, such as Smalltalk and C++, and conventional procedural programming languages, such as the “C” language or similar programming languages. Computer-readable program instructions may be executed entirely on a user's computer, partly on a user's computer, as a stand-alone software package, partly on a user's computer and partly on a remote computer, or entirely on a remote computer or server. In the case involving a remote computer, the remote computer can be connected to a user's computer through any kind of network, including a local area network (LAN) or a wide area network (WAN), or it can be connected to an external computer, for example, connected through an Internet using an Internet service provider. In some embodiments, an electronic circuit, for example, a programmable logic circuit, a field programmable gate array (FPGA), or a programmable logic array (PLA), is personalized by utilizing the state information of the computer-readable program instructions, wherein the electronic circuit may execute computer-readable program instructions so as to implement various aspects of the embodiments of the present disclosure.

Various aspects of the embodiments of the present disclosure are described here with reference to the flowcharts and/or block diagrams of the methods, the devices/systems, and the computer program products according to the embodiments of the present disclosure. It should be understood that each block of the flowcharts and/or block diagrams and combinations of blocks in the flowcharts and/or block diagrams can be implemented by computer-readable program instructions.

These computer-readable program instructions can be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing the functions/actions specified in one or more blocks in the flowcharts and/or block diagrams. These computer-readable program instructions may also be stored in a computer-readable storage medium, and these instructions cause a computer, a programmable data processing apparatus, and/or other devices to work in a specific manner; and thus the computer-readable medium having stored instructions includes an article of manufacture including instructions that implement various aspects of the functions/actions specified in one or more blocks in the flowcharts and/or block diagrams.

The computer-readable program instructions can also be loaded onto a computer, a further programmable data processing apparatus, or a further device, so that a series of operating steps can be performed on the computer, the further programmable data processing apparatus, or the further device to produce a computer-implemented process, such that the instructions executed on the computer, the further programmable data processing apparatus, or the further device can implement the functions/actions specified in one or more blocks in the flowcharts and/or block diagrams.

The flowcharts and block diagrams in the drawings illustrate the architectures, functions, and operations of possible implementations of the systems, methods, and computer program products according to various embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, the functions marked in the blocks may also occur in an order different from that marked in the accompanying drawings. For example, two successive blocks may actually be executed in parallel substantially, or they may be executed in an opposite order sometimes, depending on the functions involved. It should be further noted that each block in the block diagrams and/or flowcharts as well as a combination of blocks in the block diagrams and/or flowcharts may be implemented by using a special hardware-based system for executing specified functions or actions or by a combination of special hardware and computer instructions.

Illustrative embodiments of the present disclosure have been described above. The above description is illustrative, rather than exhaustive, and is not limited to the disclosed embodiments. Numerous modifications and alterations will be apparent to those of ordinary skill in the art without departing from the scope and spirit of the illustrated various embodiments. The selection of terms as used herein is intended to best explain the principles and practical applications of the various embodiments or technical improvements to technologies on the market, and to otherwise enable persons of ordinary skill in the art to understand the various embodiments disclosed herein.

What is claimed is:

1. A method for processing a computational graph, including:
acquiring a computational graph, wherein nodes in the computational graph represent functions related to the machine learning model, and directed edges in the computational graph represent dependencies between the functions;
determining multiple sequential portions of the computational graph wherein the multiple portions will be executed sequentially and functions corresponding to nodes in each portion can be executed in parallel; and
assigning, to the multiple portions, execution instances for executing functions corresponding to nodes in the corresponding portions, wherein the number of execution instances assigned to each portion is associated with time required to execute functions corresponding to nodes in the portion.

2. The method according to claim 1, wherein assigning, to the multiple portions, execution instances includes:
determining, based on functions corresponding to nodes in a first portion of the multiple portions, the type of processing units for providing execution instances assigned to the first portion; and
assigning, to the first portion, the execution instances provided by the processing units of the type.

3. The method according to claim 1, wherein assigning, to the multiple portions, execution instances includes:
determining execution instances to be assigned to a first portion of the multiple portions;
dividing the first portion into multiple sub-portions if the execution instances to be assigned to the first portion come from multiple processing units; and
assigning execution instances to each sub-portion, wherein the execution instances assigned to each sub-portion come from different processing units, and the number of execution instances assigned to each sub-portion is associated with time required to execute functions corresponding to nodes in the sub-portion.

4. The method according to claim 1, wherein assigning, to the multiple portions, execution instances includes:
assigning a preset number of execution instances to a first portion of the multiple portions; and
wherein the method further includes:
adjusting the execution instances assigned to the first portion during the execution of functions corresponding to nodes in the first portion.

5. The method according to claim 4, wherein adjusting the execution instances assigned to the first portion includes:
recycling execution instances among the preset number of execution instances that are not used during the execution of the functions corresponding to the nodes in the first portion.

6. The method according to claim 4, wherein adjusting the execution instances assigned to the first portion includes:
determining the number of execution instances that need to be added to the first portion, if it is determined that the preset number is less than the number of execution instances required to execute the functions corresponding to the nodes in the first portion; and
assigning the determined number of execution instances to the first portion.

7. The method according to claim 1, wherein determining the multiple portions of the computational graph includes:
determining in-degrees of multiple nodes of the computational graph, wherein an in-degree of a node represents the number of directed edges pointing to the node; and
determining the multiple portions of the computational graph based on the in-degrees.

8. The method according to claim 7, wherein determining the multiple portions of the computational graph based on the in-degrees includes iteratively performing the following actions:
selecting a first portion of the computational graph so that each node in the first portion has a preset threshold in-degree; and
removing the first portion and directed edges related to nodes in the first portion from the computational graph, so as to update the computational graph.

9. The method according to claim 1, wherein the execution instances are provided by at least one of the following:
a central processing unit; and
a dedicated processing unit.

10. An electronic device, including:
at least one processing unit; and
at least one memory which is coupled to the at least one processing unit and stores instructions for execution by the at least one processing unit, wherein the instructions, when being executed by the at least one processing unit, cause the device to perform actions including:
acquiring a computational graph, wherein nodes in the computational graph represent functions related to the machine learning model, and directed edges in the computational graph represent dependencies between the functions;
determining multiple sequential portions of the computational graph wherein the multiple portions will be executed sequentially and functions corresponding to nodes in each portion can be executed in parallel; and
assigning, to the multiple portions, execution instances for executing functions corresponding to nodes in the corresponding portions, wherein the number of execution instances assigned to each portion is associated with time required to execute functions corresponding to nodes in the portion.

11. The device according to claim 10, wherein assigning, to the multiple portions, execution instances includes:
determining, based on functions corresponding to nodes in a first portion of the multiple portions, the type of processing units for providing execution instances assigned to the first portion; and
assigning, to the first portion, the execution instances provided by the processing units of the type.

12. The device according to claim 10, wherein assigning, to the multiple portions, execution instances includes:
determining execution instances to be assigned to a first portion of the multiple portions;
dividing the first portion into multiple sub-portions if the execution instances to be assigned to the first portion come from multiple processing units; and
assigning execution instances to each sub-portion, wherein the execution instances assigned to each sub-portion come from different processing units, and the number of execution instances assigned to each sub-portion is associated with time required to execute functions corresponding to nodes in the sub-portion.

13. The device according to claim 10, wherein assigning, to the multiple portions, execution instances includes:
assigning a preset number of execution instances to a first portion of the multiple portions; and
wherein the operations further include:
adjusting the execution instances assigned to the first portion during the execution of functions corresponding to nodes in the first portion.

14. The device according to claim 13, wherein adjusting the execution instances assigned to the first portion includes:
recycling execution instances among the preset number of execution instances that are not used during the execution of the functions corresponding to the nodes in the first portion.

15. The device according to claim 13, wherein adjusting the execution instances assigned to the first portion includes:
determining the number of execution instances that need to be added to the first portion, if it is determined that the preset number is less than the number of execution instances required to execute the functions corresponding to the nodes in the first portion; and
assigning the determined number of execution instances to the first portion.

16. The device according to claim 10, wherein determining the multiple portions of the computational graph includes:
determining in-degrees of multiple nodes of the computational graph, wherein an in-degree of a node represents the number of directed edges pointing to the node; and
determining the multiple portions of the computational graph based on the in-degrees.

17. The device according to claim 16, wherein determining the multiple portions of the computational graph based on the in-degrees includes iteratively performing the following actions:
selecting a first portion of the computational graph so that each node in the first portion has a preset threshold in-degree; and
removing the first portion and directed edges related to nodes in the first portion from the computational graph, so as to update the computational graph.

18. The device according to claim 10, wherein the execution instances are provided by at least one of the following:
a central processing unit; and
a dedicated processing unit.

19. A computer program product tangibly stored in a non-transitory computer-readable medium and including machine-executable instructions, wherein the machine-executable instructions, when being executed, cause a machine to perform steps of a method for processing a computational graph, including:
acquiring a computational graph, wherein nodes in the computational graph represent functions related to the machine learning model, and directed edges in the computational graph represent dependencies between the functions;
determining multiple sequential portions of the computational graph wherein the multiple portions will be executed sequentially and functions corresponding to nodes in each portion can be executed in parallel; and
assigning, to the multiple portions, execution instances for executing functions corresponding to nodes in the corresponding portions, wherein the number of execution instances assigned to each portion is associated with time required to execute functions corresponding to nodes in the portion.

20. The computer program product according to claim 19, wherein assigning, to the multiple portions, execution instances includes:
determining, based on functions corresponding to nodes in a first portion of the multiple portions, the type of processing units for providing execution instances assigned to the first portion; and
assigning, to the first portion, the execution instances provided by the processing units of the type.
